(19) United States
(12) Patent Application Publication
(10) Pub. No.: US 2026/0096609 A1
(43) Pub. Date: Apr. 9, 2026

(54) CONTROL METHOD AND ELECTRONIC ATOMIZATION DEVICE

(71) Applicant: SHENZHEN SMOORE TECHNOLOGY LIMITED, Shenzhen (CN)

(72) Inventor: Weiming FANG, Shenzhen (CN)

(73) Assignee: SHENZHEN SMOORE TECHNOLOGY LIMITED, Shenzhen (CN)

(21) Appl. No.: 19/417,463

(22) Filed: Dec. 12, 2025

Related U.S. Application Data
(63) Continuation of application No. PCT/CN2024/087580, filed on Apr. 12, 2024.

(30) Foreign Application Priority Data
Jun. 12, 2023 (CN) 202310692258.1

(51) Int. Cl. A24F 40/57; H05B 3/22

(52) U.S. Cl. CPC A24F 40/57; H05B 3/22

(57) ABSTRACT

A control method and an electronic atomization device are provided. The control method includes selecting, based on a predetermined parameter of each of heating elements, at least one of the heating elements to heat an aerosol-forming material. The predetermined parameter is used to indicate a usage status of the heating element, Upon completion of current heating, the predetermined parameter is updated based on at least one operating parameter of the heating element during the heating. The heating element is selected, based on the usage status of the heating element each time, to participate in heating.

### RELATED APPLICATIONS

This application is a continuation application of International application No. PCT/CN2024/087580, filed on Apr. 12, 2024, which claims priority to Chinese Patent Application No. 202310692258.1 filed on Jun. 12, 2023. The entire disclosure of the prior applications is hereby incorporated by reference.

### TECHNICAL FIELD

This disclosure relates to the field of atomization technologies, including to a control method and an electronic atomization device.

### BACKGROUND

An electronic atomization device heats an aerosol-forming material through a heating element to generate an aerosol. In the related art, the electronic atomization device is equipped with a plurality of heating elements. During use of the electronic atomization device, typical problems that tend to occur include severe scaling on some heating elements due to long-term heating operation, which not only reduces the service life of individual heating elements but also affects the taste, resulting in a decline in puffing experience.

### SUMMARY

In view of this, this disclosure provide a control method and an electronic atomization device, so as to perform balanced control on heating of all heating elements. Technical solutions of the examples of this disclosure are implemented as follows.

According to an aspect of this disclosure, a control method for an electronic atomization device is provided. The electronic atomization device has a plurality of heating elements. The control method includes:
selecting, based on a predetermined parameter of each of the heating elements, at least one of the heating elements to currently heat an aerosol-forming material, where the predetermined parameter is used to indicate a usage status of the heating element; and
updating, upon completion of current heating, the predetermined parameter based on at least one operating parameter of the heating element during the current heating.

In an aspect, the selecting, based on a predetermined parameter of each of the heating elements, at least one of the heating elements to heat an aerosol-forming material includes: selecting at least one of the heating elements that has a minimum or maximum predetermined parameter.

In an aspect, the operating parameter includes electrical energy of the heating element during the current heating.

In an aspect, the electrical energy of each heating element includes an average heating power.

In an aspect, under a condition that the average heating power of each heating element is the same, the operating parameter includes a current operating duration of the heating element during the current heating.

In an aspect, under a condition that a resistance value of each heating element is the same, the operating parameter includes a product of a square of an average effective voltage of the heating element during the current heating and a current operating duration.

In an aspect, the heating element is controlled through PWM, and the operating parameter includes a product of a duty cycle of the PWM and a current operating duration.

In an aspect, an initial value of the predetermined parameter of each heating element is equal.

In an aspect, an initial value of the predetermined parameter is zero.

According to an aspect of this disclosure, an electronic atomization device is provided, including a processor and a plurality of heating elements. The processor is configured to implement the steps of the control method of any one of the above.

According to the control method provided in the examples of this disclosure, at least one heating element is selected, based on the predetermined parameter of the heating element, to heat an aerosol-forming material, and the predetermined parameter is updated based on at least one operating parameter during current heating, so that a heating element is selected, based on a predetermined parameter each time, to participate in the heating. In other words, the heating element is selected to participate in heating based on the usage status of the heating element each time, instead of all the heating elements heating the aerosol-forming material or randomly starting some heating elements to heat the aerosol-forming material in the related art, so as to avoid a problem of severe scaling on some heating elements due to long-term heating operation, enable balanced control over the heating of all heating elements, and avoid affecting overall operating performance due to significant performance differences between the heating elements caused by some heating elements operating for a long time.

### BRIEF DESCRIPTION OF THE DRAWINGS

FIG. 1 is a schematic flowchart of a control method according to an example of this disclosure.

FIG. 2 is a structural block diagram of a control device according to an example of this disclosure.

FIG. 3 is a structural block diagram of an electronic atomization device according to an example of this disclosure.

### DETAILED DESCRIPTION

To make the objectives, technical solutions, and advantages of this disclosure clearer, this disclosure is further described in detail. The described examples are not to be considered as a limitation on this disclosure. All other examples obtained by a person of ordinary skill in the art without creative efforts fall within the protection scope of this disclosure.

Unless otherwise defined, meanings of all technical and scientific terms used herein are the same as those usually understood by a person skilled in the art to which this disclosure belongs. The terms used in this specification are merely intended to describe the objectives of the examples of this disclosure, and are not intended to limit this disclosure.

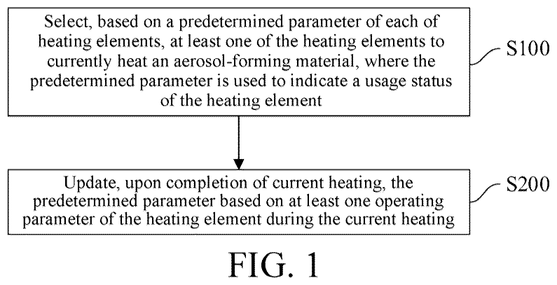

Referring to FIG. 1, an example of this disclosure provides a control method for an electronic atomization device. The electronic atomization device has a plurality of heating elements. The control method includes the following steps.

S100: Select, based on a predetermined parameter of each of the heating elements, at least one of the heating elements to currently heat an aerosol-forming material, where the predetermined parameter is used to indicate a usage status of the heating element.

The selecting at least one heating element means that one or a plurality of heating elements may be selected.

It should be noted that in the examples of this disclosure, “a plurality of” includes quantities of two and more than two.

Each heating element has a predetermined parameter, and the predetermined parameter is used to indicate a usage status of the heating element. Exemplarily, n heating elements are respectively defined as H1 to Hn, where n≥2, and the predetermined parameter is represented by En. For each operation, m of all heating elements are selected to participate in current heating, where 1≤m≤n.

S200: Update, upon completion of current heating, the predetermined parameter based on at least one operating parameter of the heating element during the current heating.

After the current heating is completed, at least one operating parameter during the current heating needs to be accumulated into the predetermined parameter, to update the predetermined parameter for next heating operation.

According to the control method provided in the examples of this disclosure, at least one heating element is selected, based on the predetermined parameter of the heating element, to heat an aerosol-forming material, and the predetermined parameter is updated based on at least one operating parameter during current heating, so that a heating element is selected, based on a predetermined parameter each time, to participate in the heating. In other words, the heating element is selected to participate in heating based on the usage status of the heating element each time, instead of all the heating elements heating the aerosol-forming material or randomly starting some heating elements to heat the aerosol-forming material in the related art, so as to avoid a problem of severe scaling on some heating elements due to long-term heating operation, enable balanced control over the heating of all heating elements, and avoid affecting overall operating performance due to significant performance differences between the heating elements caused by some heating elements operating for a long time.

In an aspect, the selecting, based on a predetermined parameter of each of the heating elements, at least one of the heating elements to heat an aerosol-forming material includes: selecting at least one of the heating elements that has a minimum or maximum predetermined parameter.

In other words, at least one operating parameter during the current heating is accumulated into the predetermined parameter. The accumulation may be accumulative addition or accumulative subtraction.

Exemplarily, the operating parameter is a positive number. If at least one operating parameter during the current heating is added to the predetermined parameter, a larger predetermined parameter indicates more usage loss of the heating element. At least one heating element with a minimum predetermined parameter is selected to heat an aerosol-forming material. In other words, at least one heating element with the minimum usage loss is selected to heat the aerosol-forming material. On the contrary, if at least one operating parameter during the current heating is accumulatively subtracted from the predetermined parameter, a smaller predetermined parameter indicates more usage loss of the heating element. At least one heating element with a maximum predetermined parameter is selected to heat the aerosol-forming material.

In an example, at least one heating element with the minimum predetermined parameter is selected. In other words, at least one heating element with the minimum predetermined parameter is selected from the plurality of heating elements to currently heat the aerosol-forming material.

The selecting at least one heating element with the minimum predetermined parameter means selecting a heating element with a minimum predetermined parameter, or selecting a plurality of heating elements with minimum predetermined parameters.

In another example, at least one heating element with the maximum predetermined parameter is selected. In other words, at least one heating element with the maximum predetermined parameter is selected from the plurality of heating elements to currently heat the aerosol-forming material.

The selecting at least one heating element with the maximum predetermined parameter means selecting a heating element with a maximum predetermined parameter, or selecting a plurality of heating elements with maximum predetermined parameters.

At least one heating element with the minimum or maximum predetermined parameter is selected to currently heat the aerosol-forming material, and the predetermined parameter is updated based on at least one operating parameter during the current heating, so that the heating element with the minimum or maximum predetermined parameter is selected to participate in the heating each time. In other words, at least one heating element with the least usage loss is selected to heat the aerosol-forming material, so as to avoid a problem of severe scaling on some heating elements due to long-term heating operation, enable balanced control over the heating of all heating elements, and avoid affecting overall operating performance due to significant performance differences between the heating elements caused by some heating elements operating for a long time.

An example in which n is 4 is used. 4 heating elements are respectively defined as H1, H2, H3, and H4. A predetermined parameter corresponding to H1 is E1, a predetermined parameter corresponding to H2 is E2, a predetermined parameter corresponding to H3 is E3, and a predetermined parameter corresponding to H4 is E4. An example in which at least one heating element with the minimum predetermined parameter is selected is used. An aspect is as follows.

In an example, if E2, E3, and E4 are all equal and less than E1, one of H2, H3, and H4 may be selected to currently heat an aerosol-forming material; or two of H2, H3, and H4 may be selected to currently heat the aerosol-forming material; or all of H2, H3, and H4 may be selected to currently heat the aerosol-forming material.

In an example, if E1, E2, E3, and E4 are all equal, one of H1, H2, H3, and H4 may be selected to currently heat the aerosol-forming material; or two of H1, H2, H3, and H4 may be selected to currently heat the aerosol-forming material; or three of H1, H2, H3, and H4 may be selected to currently heat the aerosol-forming material; or all of H1, H2, H3, and H4 may be selected to currently heat the aerosol-forming material.

In an example, if E2, E3, and E4 are all equal and greater than E1, H1 may be selected to currently heat the aerosol-forming material.

It should be understood that a person skilled in the art may learn, based on the examples, selecting at least one heating element with the maximum predetermined parameter, and details are not described herein again.

In an example, an initial value of the predetermined parameter of each heating element is equal. The initial value is a value of each heating element before first heating. In other words, the initial value is a value of a predetermined parameter at an initial moment. The initial moment is a first moment, that is, a moment when time is 0. The initial value of the predetermined parameter of each heating element is equal, so as to accumulate the operating parameter.

In an example, the initial value of the predetermined parameter is zero. In other words, a value of each heating element before the first heating is set to 0.

It may be understood that the initial value of the predetermined parameter may also be another value. For example, the initial value of the predetermined parameter may be 100.

In an example, the operating parameter includes electrical energy of the heating element during the current heating. In other words, the predetermined parameter is updated based on the electrical energy of the heating element in the current heating after the current heating is completed. In this way, the predetermined parameter includes total electrical energy of the heating element. In other words, the predetermined parameter includes total electrical energy for operation of the heating element from the initial moment to a current moment. The usage status of the heating element is indicated through the total electrical energy.

In an aspect, the electrical energy of each heating element includes an average heating power. In other words, each heating element has a respective average heating power, and the average heating power of each heating element is not associated with each other.

A manner of obtaining the electrical energy during the current heating is not limited. Exemplarily, the electrical energy for the current heating may be the average heating power of the heating element multiplied by a current operating duration. An average heating power of the heating element may be an average effective voltage of the heating element multiplied by an effective current of the heating element. If the heating element is controlled through PWM, the average heating power of the heating element may be a peak power of the heating element multiplied by a duty cycle of the PWM. It should be noted that the peak power refers to a power corresponding to a maximum amplitude of a PWM waveform.

It should be noted that PWM stands for Pulse Width Modulation, that is, pulse width modulation. The duty cycle of the PWM refers to a proportion of a power-on time to a total time in a pulse cycle.

It should be understood that the average heating power refers to power per unit time. If the heating element is heated through a constant power, the average heating power P̅ is equal to the constant power. The constant power means that the power of the heating element remains constant during the heating, that is, a frequency of work done is constant. If the heating element is heated through a variable power, the average heating power P̅ is equal to total work done, within a cycle time such as a duration of a puff, divided by a cycle time. The variable power means that the power of the heating element changes during the heating.

An example in which the heating element adopts the variable power is used. If a cycle time t=t1+t2+ . . . +tx, and power in each time period is respectively P1, P2, . . . , and Px, the average heating power P̅=(P1*t1+P2*t2+ . . . +Px*tx)/t.

It should be noted that during continuous puffing of a user, the user takes a plurality of puffs, where each puff corresponds to heating once of the heating element, and the duration of one puff by the user corresponds to one heating operation of the heating element. For example, a current puff of the user corresponds to current heating of the heating element.

In an aspect, a heating element Hn participates in heating for a K^{th} time, and after the current heating ends, a predetermined parameter En of Hn for the current heating is updated based on the electrical energy. Specifically, an average heating power P̅n of Hn during the current heating and a current operating duration Tn are calculated, and En=En_{K-1}+P̅n*Tn is updated, where En_{K-1} is a predetermined parameter of the heating element Hn after participating in the heating for a (K−1)^{th} time, that is, last time.

In an aspect, the average heating power of each heating element is the same. In this way, different parts of the aerosol-forming material or different aerosol-forming materials may be evenly heated.

In some other examples, the average heating power of each heating element is different. For different parts of the same aerosol-forming material, for example, different regions or different medium sections, heat conduction efficiency of each part of the same aerosol-forming material may be different. Heating elements with different average heating power are adopted, so that a consumption process of each part of the same aerosol-forming material may be roughly the same. For different aerosol-forming materials, different aerosol-forming materials may be made of different materials. Since the aerosol-forming materials of different materials have different components, different aerosol-forming materials may be heated and atomized through different average heating power. In other words, a same electronic atomization device may adapt to the aerosol-forming materials of different materials.

In some other examples, the average heating power of each heating element may be the same for some and different for others.

In an example, under a condition that the average heating power of each heating element is the same, the operating parameter includes a current operating duration of the heating element during the current heating. Since the average heating power of each heating element is the same, a control method may be simplified, and the predetermined parameter is accumulation of current operating durations, for example, accumulative addition. In this way, the predetermined parameter includes a total operating duration of the heating element. In other words, the predetermined parameter includes a total duration for operation of the heating element from the initial moment to a current moment. The usage status of the heating element is indicated through the total operating duration.

An example in which the predetermined parameter is accumulation of current operating durations is used. In an example, the heating element Hn participates in heating for a K^{th} time, and after the current heating ends, the predetermined parameter En of Hn during the current heating is updated based on the current operating duration. Specifically, since the average heating power of each heating element is the same, the average heating power of Hn during the current heating may not be calculated, only a current operating duration Tn of Hn during the current heating is calculated, and En=En_{K-1}+Tn is updated.

In an example, under a condition that a resistance value of each heating element is the same, the operating parameter includes a product of a square of an average effective voltage of the heating element during the current heating and a current operating duration. The heating element can convert electric energy into thermal energy. For example, the heating element is of a resistive heating structure. Since the resistance value of each heating element is the same, the predetermined parameter may be simplified to adopt accumulation of a square of the average effective voltage multiplied by the current operating duration. In this way, the predetermined parameter includes a value obtained by multiplying the square of the average effective voltage of the heating element by the current operating duration. The usage status of the heating element is indicated through the accumulation of the square of the average effective voltage multiplied by the current operating duration.

It should be understood that a voltage applied to each heating element may be a constant voltage or a variable voltage. The average effective voltage refers to a voltage that generates equivalent power on the resistance value of the heating element within a cycle time, for example, within a time period of one puff. If the heating element is heated through a constant voltage, the average effective voltage Ū is equal to the constant voltage. The constant voltage means that the voltage of the heating element remains constant during heating. If the heating element is heated through a variable voltage, the average effective voltage Ū is equal to a voltage that generates equivalent power on the resistance value of the heating element within a cycle time, for example, within a time period of one puff. The variable voltage means that the voltage of the heating element changes during the heating.

Exemplarily, Ūn represents an average effective voltage applied to each heating element. For the heating element Hn, a resistance value is represented by Rn, and then Pn=Ūn²/Rn. The heating element Hn participates in heating for the K^{th} time, and after the current heating ends, the predetermined parameter En of Hn for the current heating is updated based on Ūn²*Tn. Specifically, under a condition that the resistance value of each heating element is the same, the resistance value Rn of Hn during the current heating may not be calculated, only an average effective voltage Un and the current operating duration Tn of Hn during the current heating are calculated, and En=En_{K-1}+Ūn²*Tn is updated.

In an example, the heating element is controlled through PWM, and the operating parameter includes a product of a duty cycle of the PWM and a current operating duration. For an application in which heating is outputted through PWM, since the average heating power of the heating element is equal to the peak power of the PWM multiplied by the duty cycle of the PWM, and the peak power of the PWM is a constant value, En may be simplified to accumulation of the duty cycle of the PWM multiplied by the current operating duration. In this way, the predetermined parameter includes a value of the duty cycle of the PWM multiplied by the current operating duration. The usage status of the heating element is indicated through the accumulation of the duty cycle of the PWM multiplied by the current operating duration.

Exemplarily, for a heating element Hn, the peak power of the PWM is represented by Pn′, the duty cycle of the PWM is represented by Dn, and then Pn=Pn′*Dn. The heating element Hn participates in heating for the K^{th} time, and after the current heating ends, the predetermined parameter En of Hn for the current heating is updated based on Dn*Tn. Specifically, Pn′ of Hn during the current heating may not be calculated, only the duty cycle Dn of Hn during the current heating and the current operating duration Tn are calculated, and En=En_{K-1}+Dn*Tn is updated.

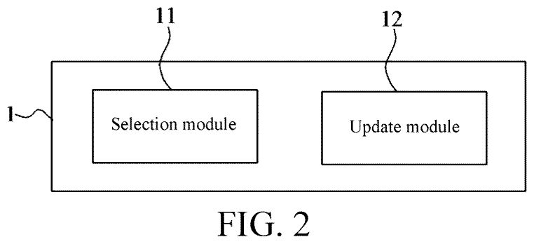

Referring to FIG. 2, an example of this disclosure provides a control device 1. The control device 1 includes a selection module 11 and an update module 12.

The selection module 11 is configured to select, based on a predetermined parameter of each of heating elements 1300, at least one of the heating elements 1300 to currently heat an aerosol-forming material, where the predetermined parameter is used to indicate a usage status of the heating element 1300.

The update module 12 is configured to update, upon completion of current heating, the predetermined parameter based on at least one operating parameter of the heating element 1300 during the current heating.

Regarding the control device 1 in the foregoing example, a specific manner in which each module performs the operation has been described in detail in the examples of the control method, and details are not described herein again.

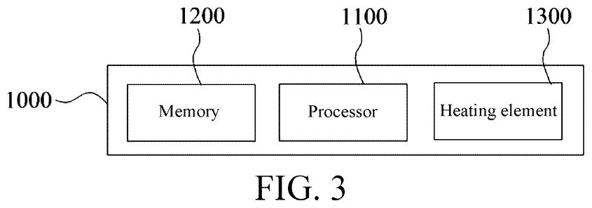

Referring to FIG. 3, an example of this disclosure further provides an electronic atomization device 1000. The electronic atomization device 1000 includes a processor 1100, a memory 1200, and a plurality of heating elements 1300. Each of the heating elements 1300 is configured to heat an aerosol-forming material. The memory 1200 is configured to store a computer program that can run on the processor 1100. When the processor 1100 is configured to run the computer program, the steps of the control method of any one of the examples of this disclosure are implemented.

The aerosol-forming material is configured to be heated by the heating element 1300 to generate an aerosol. Exemplarily, the aerosol-forming material may be suitable for generating the aerosol in a heat-not-burn manner. In other words, the aerosol-forming material is heated below an ignition point to generate an aerosol. The aerosol-forming material does not burn when generating the aerosol. The electronic atomization device 1000 is configured for a user to inhale the aerosol generated by the aerosol-forming material.

A specific type of the electronic atomization device 1000 is not limited. Exemplarily, the electronic atomization device 1000 includes, but is not limited to, an air humidifier, a medical atomizer, an e-cigarette, or the like.

The aerosol-forming material may be solid or liquid.

For the solid aerosol-forming material, a detailed description is as follows.

The aerosol-forming material may include a botanical composition, an auxiliary composition, a smoking agent composition, an adhesive composition, and the like. The botanical composition may be a combination of one or more of powders that is formed after crushing treatment is performed on a tobacco leaf raw material, a tobacco leaf fragment, a tobacco stem, a tobacco waster, an aromatic plant, or the like. The botanical composition is used to generate an aerosol with an alkaloid when heated.

In an example, the aerosol-forming material is integrally formed. For example, the aerosol-forming material may be an integrated structure formed by injection molding, compression molding, or an extrusion process. The extrusion molding refers to a processing method in which a raw material mixture is added into an extruder. Through the interaction between a barrel and a screw of the extruder, the raw material mixture is pushed forward by the screw to pass continuously through a die head, thereby producing products or semi-finished products with various cross-sections. An aerosol-forming material formed through the extrusion molding is in a shape of a strip. In this way, during heating and puffing or after ceasing to be heated, the aerosol-forming material remains an integrated medium and is less prone to the problem of disintegration and falling off.

In an example, the aerosol-forming material may be roughly in a columnar structure. In other words, the aerosol-forming material is roughly in an elongated shape, and a length of the aerosol-forming material in a longitudinal direction is greater than a distance between any two points on a cross section thereof.

On a cross section perpendicular to the longitudinal direction of the aerosol-forming material, a shape of the cross section of the aerosol-forming material includes, but is not limited to, a circle, an ellipse, a runway, a polygon, or the like. An example in which the shape of the cross section of the aerosol-forming material is a circle is used. The aerosol-forming material is roughly in a shape of a cylinder, and the longitudinal direction of the aerosol-forming material is an axial direction of the cylinder.

In an example, the heating element is located on a periphery of the aerosol-forming material, the aerosol-forming material is divided into a plurality of regions along a circumferential direction, and each region corresponds to one heating element. In this way, different regions of the aerosol-forming material along the circumferential direction may be selectively heated through different heating elements, and different parts of the aerosol-forming material are selected to respectively release the aerosol, so that the aerosol inhaled by the user in each puff may be fresher, and the taste is enriched.

In an example, a cavity is formed inside the aerosol-forming material, the heating element is located in the cavity, the aerosol-forming material is divided into a plurality of regions along a circumferential direction, and each region corresponds to one heating element. In this way, different regions of the aerosol-forming material may also be selectively heated through different heating elements.

In an example, the aerosol-forming material may have a plurality of medium sections along a length direction. Each medium section corresponds to one heating element. In this way, different medium sections of the aerosol-forming material may be selectively heated through different heating elements.

In an example, a plurality of aerosol-forming materials are provided in each electronic atomization device. In other words, a plurality of aerosol-forming materials may be provided. Each aerosol-forming material corresponds to one heating element. In this way, different aerosol-forming materials may be selectively heated through different heating elements.

For the liquid aerosol-forming material, a detailed description is as follows.

The liquid substrate may be a medicine or another substance such as e-liquid. Exemplarily, the liquid substrate includes a solvent and an additive. The solvent includes, but is not limited to, propylene glycol and/or glycerol. The additive may include nicotine salt, a plant extract, a flavor additive, and/or the like. The flavor additive may be flavors and fragrances.

In an example, the electronic atomization device includes a substrate and a liquid reservoir for storing a liquid aerosol-forming material. The substrate includes a plurality of heating surfaces. A heating element is arranged on each of the heating surfaces. The substrate can guide the liquid aerosol-forming material in the liquid reservoir to the heating surface. For example, the substrate may have a liquid guide hole, and the liquid guide hole guides the liquid aerosol-forming material to the heating surface. In this way, the aerosol-forming materials on different heating surfaces may be heated through different heating elements.

The substrate may be of a porous structure. The porous structure refers to a structure with a plurality of holes therein that are in communication with each other and in communication with an outer surface of the substrate. The holes in the porous structure facilitate temporary storage of the liquid substrate, and also facilitate circulation of the liquid substrate. The plurality of holes in the porous structure may be arranged in disorder. In other words, the holes in the porous structure are randomly generated.

The substrate may be made of a ceramic material. The ceramic material has characteristics such as good thermal conductivity and uniformity. Exemplarily, the substrate may be made of a dense ceramic material or a porous ceramic material. The porous ceramic material may be generated through high-temperature sintering of components such as an aggregate, a binder, and a pore-forming agent. During sintering of porous ceramics, the pore-forming agents generate disorderly arranged holes in the porous ceramics.

It should be noted that in this disclosure, each heating element may be independently controlled. That each heating element may be independently controlled means that turn-on, turn-off, temperature adjustment, or the like of each heating element may be separately controlled. For example, each heating element is powered independently, so that each heating element can be controlled independently.

In an aspect, the heating element may be of a resistive heating structure. The heating element may be a heating wire, a heating mesh, or a heating sheet.

In an aspect, the electronic atomization device includes a power supply unit. The power supply unit is configured to supply power to an electric device such as a heating element. The power supply unit includes, but is not limited to, a device such as a battery that can provide electric energy. A power source includes, but is not limited to, a battery. The battery may be a disposable battery or a rechargeable battery.

In an example, the electronic atomization device includes a master controller, and the processor and the memory may both be arranged on the master controller. The master controller may be configured to control functions such as operation of the electronic atomization device and detection of a battery level of the power supply unit. The master controller may further detect a resistance value of the heating element, a voltage applied to the heating element, a current operating duration of the heating element during current heating, and/or the like.

The master controller includes, but is not limited to, a microcontroller unit (MCU). The master controller may detect the resistance value of the heating element, the voltage applied to the heating element, and/or the current operating duration of the heating element during current heating. In this way, the operating parameter such as the electrical energy of the heating element during the current heating may further be obtained through calculation.

An example of this disclosure further provides a storage medium, having a computer program stored therein, where the computer program, when executed by a processor, implements the steps of the control method according to any one of the examples of this disclosure.

The foregoing descriptions of the examples of the control device 1, the electronic atomization device 1000, and the storage medium are similar to the description of any one of the examples of the foregoing control method, and have the same beneficial effects as the examples of the control method. For technical details of the control device 1, the electronic atomization device 1000, and the storage medium that are not disclosed in the examples of this disclosure, reference is made to the descriptions of the examples of the control method in the examples of this disclosure for understanding.

It should be noted that in the examples of this disclosure, when the foregoing control method is implemented in the form of a software functional module and sold or used as an independent product, the control method may also be stored in a computer-readable storage medium. Based on such an understanding, the technical solutions of the examples of this disclosure essentially or a part contributing to the related art may be essentially embodied in a form of a software product. The computer software product is stored in a storage medium, and includes several instructions for enabling the electronic atomization device to perform all or part of the control method in the examples of this disclosure. The foregoing storage medium includes: any storage medium that can store program code, such as a USB flash disk, a mobile hard disk, a read only memory (ROM), a magnetic disk, or an optical disk. In this way, the examples of this disclosure are not limited to any combination of specific hardware and software.

It should be understood that phrases “in an example”, “in some embodiments”, “in some other embodiments”, and the like mentioned throughout the specification mean that specific features, structures, or characteristics related to the example are included in at least one example of this disclosure. Therefore, the phrases “in an embodiment”, “in some embodiments”, and “in some other embodiments” appearing in various places throughout the specification does not necessarily refer to the same example. In addition, these specific features, structures, or characteristics may be combined in a proper manner in one or more examples. It should be understood that sequence numbers of the foregoing processes do not mean execution sequences in various examples of this disclosure. The execution sequences of the processes should be determined based on functions and internal logic of the processes, and should not constitute any limitation on the implementation processes of the examples of this disclosure. The sequence numbers of the foregoing examples of this disclosure are merely for description, and do not represent preference of the examples.

In this disclosure, it should be understood that the disclosed device and method may be implemented in other manners. The device example described above is merely an example. For example, division of units is merely division of logical functions, and may be another division during actual implementation. For example, a plurality of units or components may be combined or may be integrated into another system, or some features may be ignored or not performed. In addition, the displayed or discussed mutual couplings or direct couplings or communication connections between components may be implemented through some interfaces. The indirect couplings or communication connections between the devices or units may be implemented in an electronic form, a mechanical form, or another form.

The foregoing descriptions are merely examples of this disclosure, but the protection scope of this disclosure is not limited thereto. Any variation or replacement readily figured out by a person skilled in the art within the technical scope of this disclosure shall fall within the protection scope of this disclosure. Therefore, the protection scope of this disclosure shall be subject to the protection scope of the claims.

What is claimed is:

1. A control method for an electronic atomization device including a plurality of heating elements, and the control method comprises:
selecting, based on a predetermined parameter of one of the plurality of heating elements, at least one of the plurality of heating elements to heat an aerosol-forming material, wherein the predetermined parameter is used to indicate a usage status of the one of the plurality of heating elements;
heating the aerosol-forming material; and
updating, upon completion of the heating, the predetermined parameter based on operating parameter of the one of the plurality of heating elements during the heating.

2. The control method of claim 1, wherein the selecting further comprises:
selecting at least one of the plurality of heating elements with a minimum or a maximum predetermined parameter.

3. The control method of claim 1, wherein the operating parameter comprises electrical energy of the heating element during the heating.

4. The control method of claim 3, wherein the electrical energy of each heating element comprises an average heating power.

5. The control method of claim 4, wherein when the average heating power of each heating element is the same, the operating parameter includes a current operating duration of the heating element during the heating.

6. The control method of claim 1, wherein when a resistance value of each of the plurality of heating elements is the same, the operating parameter comprises a product of a square of an average effective voltage of the heating element during the heating and a current operating duration.

7. The control method of claim 1, wherein the operating parameter comprises a product of a duty cycle of PWM and a current operating duration.

8. The control method of claim 1, wherein an initial value of the predetermined parameter of each of the plurality of heating elements is equal.

9. The control method of claim 8, wherein the initial value of the predetermined parameter is zero.

10. An electronic atomization device comprising:
a processor and a plurality of heating elements, wherein the processor is configured to
select, based on a predetermined parameter of one of the plurality of heating elements, at least one of the plurality of heating elements to heat an aerosol-forming material, wherein the predetermined parameter is used to indicate a usage status of the one of the plurality of heating elements,
heat the aerosol-forming material, and
update, upon completion of the heating, the predetermined parameter based on operating parameter of the one of the plurality of heating elements during the heating.

11. The electronic atomization device of claim 10, wherein the processor is configured to:
select at least one of the plurality of heating elements with a minimum or a maximum predetermined parameter.

12. The electronic atomization device of claim 10, wherein the operating parameter comprises electrical energy of the heating element during the heating.

13. The electronic atomization device of claim 12, wherein the electrical energy of each heating element comprises an average heating power.

14. The electronic atomization device of claim 13, wherein when the average heating power of each heating element is the same, the operating parameter includes a current operating duration of the heating element during the heating.

15. The electronic atomization device of claim 10, wherein when a resistance value of each of the plurality of heating elements is the same, the operating parameter comprises a product of a square of an average effective voltage of the heating element during the heating and a current operating duration.

16. The electronic atomization device of claim 10, wherein the operating parameter comprises a product of a duty cycle of PWM and a current operating duration.

17. The electronic atomization device of claim 10, wherein an initial value of the predetermined parameter of each of the plurality of heating elements is equal.

18. The electronic atomization device of claim 17, wherein the initial value of the predetermined parameter is zero.
